(19) United States
(12) Patent Application Publication
(10) Pub. No.: US 2025/0004110 A1
(43) Pub. Date: Jan. 2, 2025

(54) LIDAR Systems with Improved Time-To-Digital Conversion Circuitry

(71) Applicant: SEMICONDUCTOR COMPONENTS INDUSTRIES, LLC, Scottsdale, AZ (US)

(72) Inventor: Anthony Richard HUGGETT, Tadley (GB)

(73) Assignee: SEMICONDUCTOR COMPONENTS INDUSTRIES, LLC, Scottsdale, AZ (US)

(21) Appl. No.: 18/343,045

(22) Filed: Jun. 28, 2023

(51) Int. Cl. G01S 7/4863; G01S 7/4865; G01S 17/10

(52) U.S. Cl. CPC G01S 7/4863; G01S 7/4865; G01S 17/10

(57) ABSTRACT

A light detection and ranging (LIDAR) system may include a laser and a plurality of single photon avalanche diodes (SPADs) that are produce signals in response to laser light that reflects off a target scene. The LIDAR system may be a direct time-of-flight system and may further include processing circuitry that includes a transform circuit, an integration circuit, and a decoding circuit. The transform circuit may transform the signals produced by the SPADs, such as transforming the signals into a lower dimensional space. For example, the transform circuit may transform the signals into vectors in a two-dimensional complex plane. The integration circuit may combine the transformed signals to form an integrated value, such as by adding the vectors. The decoding circuit may determine the time-of-flight of the external object using the integrated value.

### BACKGROUND

This relates generally to imaging systems, and more specifically, to LIDAR (light detection and ranging) based imaging systems.

Conventional LIDAR imaging systems illuminate a target with light (typically a coherent laser pulse) and measure the return time of reflections off the target to determine a distance to the target and light intensity to generate three-dimensional images of a scene. The LIDAR imaging systems include direct time-of-flight circuitry and lasers that illuminate a target. The time-of-flight circuitry may determine the flight time of laser pulses (e.g., having been reflected by the target), and thereby determine the distance to the target. In direct time-of-flight LIDAR systems, this distance is determined for each pixel in an array of single-photon avalanche diode (SPAD) pixels that form an image sensor.

### BRIEF DESCRIPTION OF THE DRAWINGS

FIG. 1 is a schematic diagram of an illustrative system that includes a LIDAR imaging system in accordance with some embodiments.

FIG. 2 is a circuit diagram showing an illustrative single-photon avalanche diode (SPAD) pixel in accordance with some embodiments.

FIG. 3 is a diagram of an illustrative silicon photomultiplier in accordance with some embodiments.

FIG. 4 is a schematic diagram of illustrative LIDAR processing circuitry in accordance with some embodiments.

FIGS. 5A-5D are diagrams of illustrative transforms that may be used to transform signals produced by SPAD pixels in accordance with some embodiments.

FIG. 6 is a diagram of illustrative transformed vectors produced by SPAD pixels in accordance with some embodiments.

FIG. 7 is a diagram of an illustrative integrated vector that is a combination of transformed vectors in accordance with some embodiments.

FIG. 8 is a flowchart of illustrative steps that may be used to produce a direct time-of-flight measurement in accordance with some embodiments.

### DETAILED DESCRIPTION

Embodiments herein relate to LIDAR systems having direct time-of-flight capabilities.

Some imaging systems include image sensors that sense light by converting impinging photons into charge carriers (electrons and holes) that are integrated (collected) in pixel photodiodes within the sensor array. After completion of an integration cycle, collected charge is converted into a voltage, which is supplied to the output terminals of the sensor. In complementary metal-oxide semiconductor (CMOS) image sensors, the charge to voltage conversion is accomplished directly in the pixels themselves and the analog pixel voltage is transferred to the output terminals through various pixel addressing and scanning schemes. The analog pixel voltage can also be later converted on-chip to a digital equivalent and processed in various ways in the digital domain.

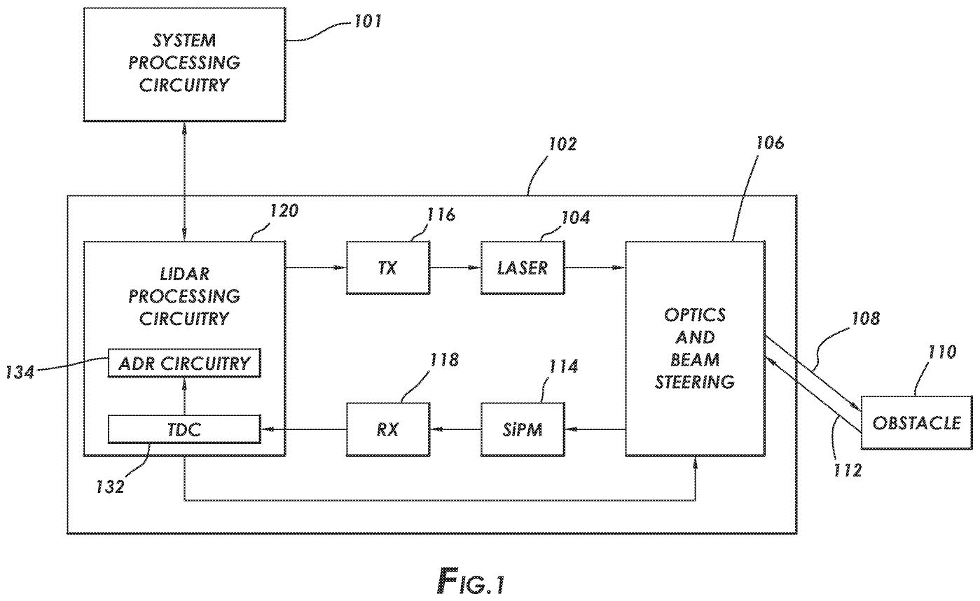

In light detection and ranging (LIDAR) devices, such as the ones described in connection with FIGS. 1-4, on the other hand, the photon detection principle is different. LIDAR devices may include a light source, such as a laser, that emits light toward a target object/scene. Each light sensing diode in the LIDAR devices may be biased slightly above its breakdown point and when an incident photon from the laser, such as light that has reflected off of the target object/scene, generates charge carriers (an electron and a hole), these carriers initiate an avalanche breakdown with additional carriers being generated. The avalanche multiplication may produce a current signal that can be easily detected by readout circuitry associated with single-photon avalanche diode (SPAD). The avalanche process needs to be stopped (quenched) by lowering the diode bias below its breakdown point.

In LIDAR devices, SPAD pixels may be used to measure photon time-of-flight (ToF) from a synchronized light source to a scene object point and back to the sensor, which can be used to obtain a 3-dimensional image of the scene. This method requires time-to-digital conversion circuitry to determine an amount of time that has elapsed since the laser light has been emitted and thereby determine a distance to the target object. For example, histograms of signals generated by each SPAD pixel may be created to determine the ToF. However, these histograms may require storing significant amounts of data and therefore require a large amount of memory. Therefore, instead of storing data to form these histograms, transforms may be used on each signal generated by the SPAD pixels. The transformed values may then be summed (or otherwise combined) to determine the ToF.

FIG. 1 is a schematic diagram of an illustrative system that includes a LIDAR imaging system. System 100 of FIG. 1 may be vehicle system, such as an active braking system or other vehicle safety system, a surveillance system, a medical imaging system, a general machine vision system, or any other desired type of system.

System 100 includes a LIDAR-based system 102, such as a LIDAR imaging system, sometimes referred to as a LIDAR module. LIDAR module 102 may be used to capture images of a scene and measure distances to obstacles (also referred to as targets) in the scene.

As an example, in a vehicle safety system, information from the LIDAR module may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane-drift avoidance system), or a pedestrian detection system. In at least some instances, a LIDAR module may form part of a semi-autonomous or autonomous self-driving vehicle.

LIDAR module 102 may include laser 104 that emits light 108 to illuminate obstacle 110 (also referred to as a target or scene herein). The laser may emit light 108 at any desired wavelength, such as infrared light or visible light. Optics and beam-steering equipment 106 may be used to direct the light beam from laser 104 toward obstacle 110. Light 108 may illuminate obstacle 110 and return to LIDAR module 102 as reflection 112. One or more lenses in optics and beam-steering 106 may focus reflected light 112 onto silicon photomultiplier (SiPM) 114 (sometimes referred to as SiPM sensor 114).

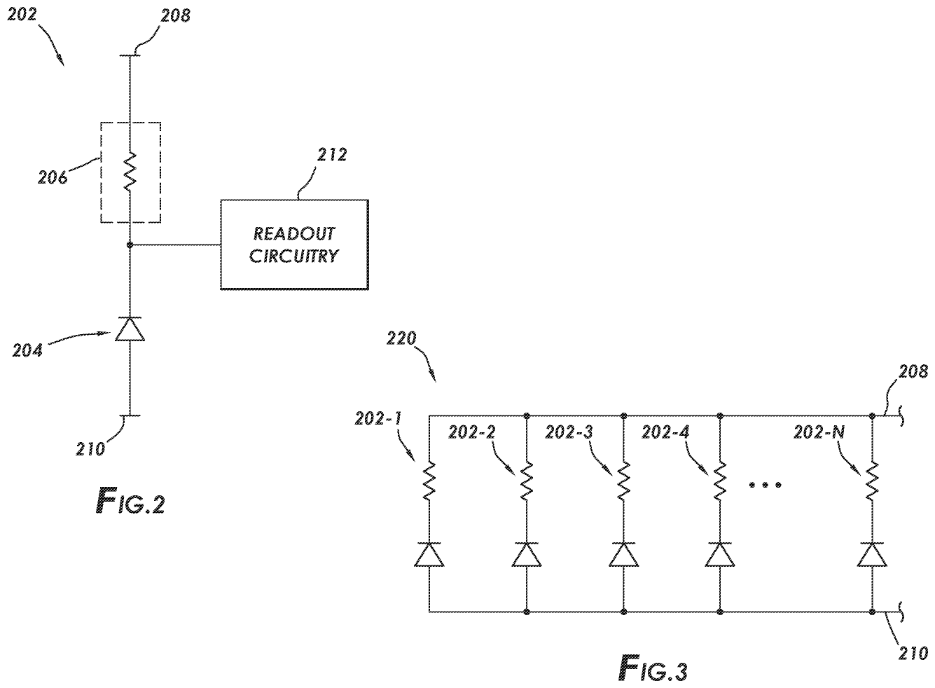

SiPM 114 is a SPAD device. In other words, SiPM 114 may include a plurality of SPADs. In SPAD devices, the light sensing diode is biased above its breakdown point. When an incident photon generates a pair of charge carriers (an electron and a hole), these carriers initiate an avalanche breakdown with additional carriers being generated. The avalanche multiplication may produce a current signal that can be easily detected by readout circuitry associated with the SPAD. The avalanche process can be stopped (quenched) by lowering the diode bias below its breakdown point. Each SPAD may therefore include a passive and/or active quenching circuit for halting the avalanche. The SPAD pixels may be used to measure photon ToF from a synchronized light source, such as laser 104, to a scene object point and back to the sensor, which can be used to obtain a 3-dimensional image of the scene. An illustrative example of a SPAD pixel that may be used in silicon photomultiplier 114 is shown in FIG. 2.

As shown in FIG. 2, SPAD device 202 includes SPAD 204 that is coupled in series with quenching circuitry 206 between a first supply voltage terminal 208, which may be a ground power supply voltage terminal, for example, and a second supply voltage terminal 210, which may be a power supply voltage terminal, for example. During operation of SPAD device 202, supply voltage terminals 208 and 210 may be used to bias SPAD 204 to a voltage that is higher than the breakdown voltage. Breakdown voltage is the largest reverse voltage that can be applied without causing an exponential increase in the leakage current in the diode. When SPAD 204 is biased above the breakdown voltage in this manner, absorption of a single-photon can trigger a short-duration but relatively large avalanche current through impact ionization.

Quenching circuitry 206 (sometimes referred to as quenching element 206) may be used to lower the bias voltage of SPAD 204 below the level of the breakdown voltage. Lowering the bias voltage of SPAD 204 below the breakdown voltage stops the avalanche process and corresponding avalanche current. There are numerous ways to form quenching circuitry 206. Quenching circuitry 206 may be passive quenching circuitry or active quenching circuitry. Passive quenching circuitry may automatically quench the avalanche current without external control or monitoring once initiated. For example, FIG. 2 shows an example where a resistor is used to form quenching circuitry 206. This is an example of passive quenching circuitry. After the avalanche is initiated, the resulting current rapidly discharges the capacity of the device, lowering the voltage at the SPAD to near to the breakdown voltage. The resistance associated with the resistor in quenching circuitry 206 may result in the final current being lower than required to sustain itself. The SPAD may then be reset to above the breakdown voltage to enable detection of another photon.

This example of passive quenching circuitry is merely illustrative. Active quenching circuitry may also be used in SPAD device 202. Active quenching circuitry may reduce the time it takes for SPAD device 202 to be reset. This may allow SPAD device 202 to detect incident light at a faster rate than when passive quenching circuitry is used, improving the dynamic range of the SPAD device. Active quenching circuitry may modulate the SPAD quench resistance. For example, before a photon is detected, quench resistance is set high and then once a photon is detected and the avalanche is quenched, quench resistance is minimized to reduce recovery time.

SPAD device 202 may also include readout circuitry 212. There are numerous ways to form readout circuitry 212 to obtain information from SPAD device 202. Readout circuitry 212 may include a pulse counting circuit that counts arriving photons. Alternatively or in addition, readout circuitry 212 may include ToF circuitry that is used to measure photon ToF. The photon ToF information may be used to perform depth sensing.

In one example, photons may be counted by an analog counter to form a light intensity signal as a corresponding pixel voltage. In other words, the pixel voltage may correspond to the light intensity on the SPAD device. The ToF signal may be obtained by also converting the time of photon flight to a voltage. The example of an analog pulse counting circuit being included in readout circuitry 212 is merely illustrative. If desired, readout circuitry 212 may include digital pulse counting circuits. Readout circuitry 212 may also include amplification circuitry if desired.

The example in FIG. 2 of readout circuitry 212 being coupled to a node between diode 204 and quenching circuitry 206 is merely illustrative. Readout circuitry 212 may be coupled to any desired portion of the SPAD device. In some cases, quenching circuitry 206 may be considered integral with readout circuitry 212.

Because SPAD devices can detect a single incident photon, the SPAD devices are effective at imaging scenes with low light levels. Each SPAD may detect how many photons are received within a given period of time, such as by using readout circuitry that includes a counting circuit. However, as discussed above, each time a photon is received and an avalanche current initiated, the SPAD device must be quenched and reset before being ready to detect another photon. As incident light levels increase, the reset time becomes limiting to the dynamic range of the SPAD device. In particular, once incident light levels exceed a given level, the SPAD device is triggered immediately upon being reset. Moreover, the SPAD devices may be used in a LIDAR system to determine when light has returned after being reflected from an external object.

Multiple SPAD devices may be grouped together to help increase dynamic range. The group or array of SPAD devices may be referred to as an SiPM. Two SPAD devices, more than two SPAD devices, more than ten SPAD devices, more than one hundred SPAD devices, more than one thousand SPAD devices, or any other suitable number of SPAD devices may be included in a given SiPM. An example of multiple SPAD devices grouped together is shown in FIG. 3.

FIG. 3 is a circuit diagram of an illustrative group 220 of SPAD devices 202. The group of SPAD devices may be referred to as an SiPM. As shown in FIG. 3 silicon photomultiplier 220 may include multiple SPAD devices that are coupled in parallel between first supply voltage terminal 208 and second supply voltage terminal 210. FIG. 3 shows N SPAD devices 202 coupled in parallel as SPAD device 202-1, SPAD device 202-2, SPAD device 202-3, SPAD device 202-4, . . . . SPAD device 202-N.

Herein, each SPAD device may be referred to as a SPAD pixel 202. Although not shown explicitly in FIG. 3, readout circuitry for the SiPM measure the combined output current from all of SPAD pixels in the SiPM. In this way, the dynamic range of an imaging system including the SPAD pixels may be increased. However, if desired, each SPAD pixel may have individual readout circuitry. Each SPAD pixel is not guaranteed to have an avalanche current triggered when an incident photon is received. The SPAD pixels may have an associated probability of an avalanche current being triggered when an incident photon is received. There is a first probability of an electron being created when a photon reaches the diode and then a second probability of the electron triggering an avalanche current. The total probability of a photon triggering an avalanche current may be referred to as the SPAD's photon-detection efficiency (PDE). Grouping multiple SPAD pixels together in the SiPM therefore allows for a more accurate measurement of the incoming incident light. For example, if a single SPAD pixel has a PDE of 50% and receives one photon during a time period, there is a 50% chance the photon will not be detected. With the SiPM 220 of FIG. 3, there is a greater than 50% chance are that two of the four SPAD pixels will detect the photon, thus improving the provided image data for the time period and allowing for a more accurate measurement of the incoming light.

The example of a plurality of SPAD pixels having a common output in an SiPM is merely illustrative. In the case of an imaging system including an SiPM having a common output for all of the SPAD pixels, the imaging system may not have any resolution in imaging a scene. In other words, the SiPM can just detect photon flux at a single point. It may be desirable to use SPAD pixels to obtain image data across an array to allow a higher resolution reproduction of the imaged scene. In cases such as these, SPAD pixels in a single imaging system may have per-pixel readout capabilities. Alternatively, an array of SiPMs, each including more than one SPAD pixel, may be included in the imaging system. The outputs from each pixel or from each SiPM may be used to generate image data for an imaged scene. The array may be capable of independent detection, whether using a single SPAD pixel or a plurality of SPAD pixels in an SiPM, in a line array, such as an array having a single row and multiple columns or a single column and multiple rows or an array having more than ten, more than one hundred, or more than one thousand rows and/or columns.

Returning to FIG. 1, LIDAR module 102 may also include a transmitter 116 and receiver 118. LIDAR processing circuitry 120 may control transmitter 116 and laser 104. LIDAR processing circuitry 120 may include processing circuitry and storage and may be configured to perform operations using hardware, such as dedicated hardware or circuitry, firmware and/or software. Software code for performing operations and other data may be stored on non-transitory computer readable storage media, such as tangible computer readable storage media, in the processing circuitry. Remote storage and other remote-control circuitry, such as circuitry on remote servers, may also be used in storing the software code. The software code may sometimes be referred to as software, data, program instructions, computer instructions, instructions, or code. The non-transitory computer readable storage media may include non-volatile memory such as non-volatile random-access memory, one or more hard drives, such as magnetic drives or solid-state drives, one or more removable flash drives or other removable media, or other storage. Software stored on the non-transitory computer readable storage media may be executed on the processing circuitry and/or the processing circuitry of remote hardware such as processors associated with one or more remote servers that communicate over wired and/or wireless communications links. The processing circuitry may include application-specific integrated circuits with processing circuitry, one or more microprocessors, a central processing unit (CPU) or other processing circuitry.

The LIDAR processing circuitry 120 may also receive data from receiver 118 and SiPM 114. Based on the data from SiPM 114, LIDAR processing circuitry 120 may determine a distance to the obstacle 110. The LIDAR processing circuitry 120 may communicate with system processing circuitry 101. System processing circuitry 101 may take corresponding action, such as on a system-level, based on the information from LIDAR module 102.

LIDAR processing circuitry 120 may include time-to-digital converter (TDC) circuitry 132 and autonomous dynamic resolution (ADR) circuitry 134. The time-to-digital converter circuitry 132 may use time values, such as the time between the laser emitting light and the reflection being received by SiPM 114, to obtain a digital value representative of the distance to the obstacle 110.

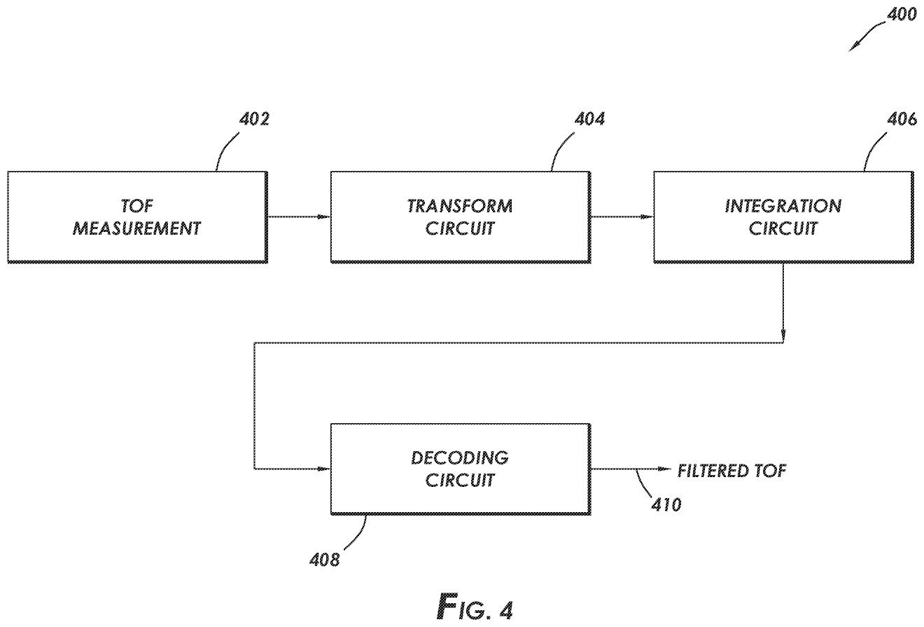

The readout for direct ToF LIDAR may be achieved using multiple LASER cycles to create a histogram in memory based on the time-stamps generated by a SPAD and TDC. The peak of the histogram may then be used to determine the time taken for the LASER signal to travel to the target and return to the sensor. However, generating a histogram of all of the time-stamps may require a very large memory. Therefore, improved TDC circuitry and ToF determinations may desired. An illustrative example of LIDAR circuitry that may be used to measure the distance to an obstacle, such as obstacle 110, is shown in FIG. 4.

As shown in FIG. 4, LIDAR circuitry 400, which may be a part of LIDAR processing circuitry 120 of FIG. 1, may first generate ToF measurement 402. As discussed in connection with FIGS. 1-3, ToF measurement 402 may be a measurement generated by a SPAD pixel 202 in SiPM 220. In particular, the measurements may be based on the time-stamps generated by SPAD pixels 202. Multiple SPAD pixels 202 in SiPM 220 may be triggered by light and generate ToF measurements 402. In particular, each SPAD pixel 202 that detects light that has reflected off of an external object may generate a ToF measurement based on the time that it took for the light to be emitted and reflected back to the SPAD pixels 202. Additionally, each SPAD pixel 202 that detects stray light (e.g., ambient light) may also generate a ToF measurement.

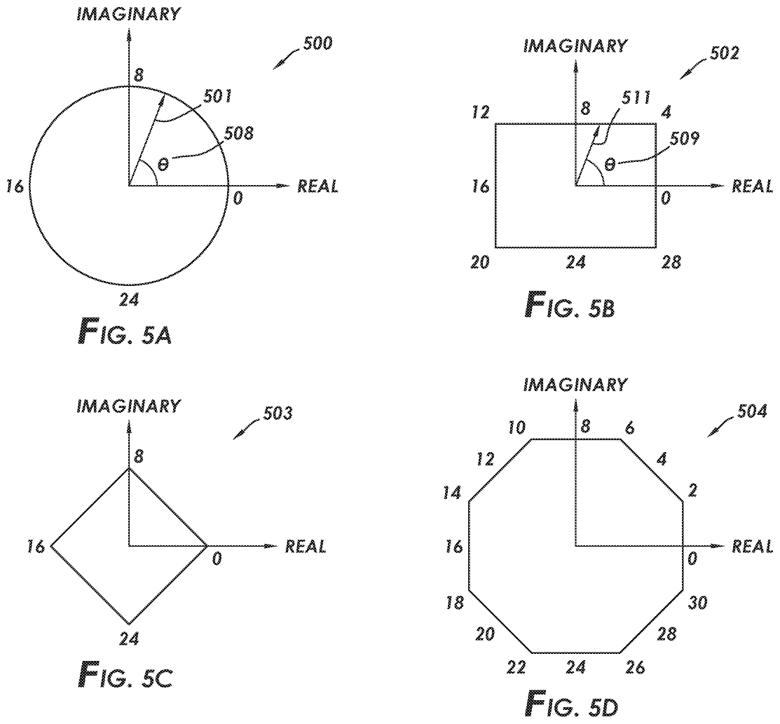

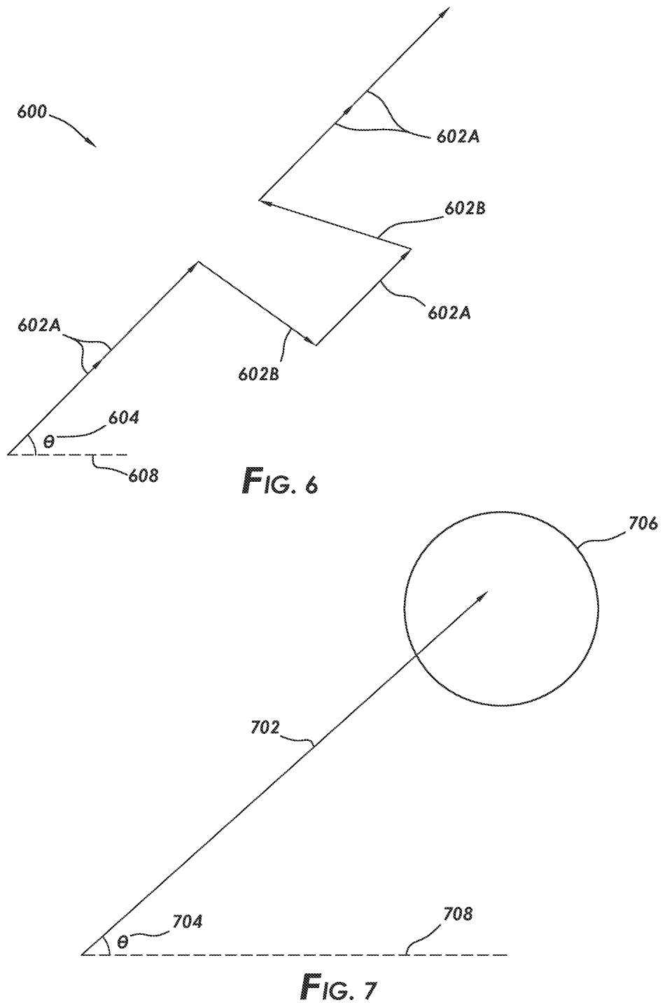

Transform circuit 404 may apply a transform to each ToF measurement 402. In particular, each ToF measurement 402 may include information regarding the time at which light is incident on each SPAD pixel 202. Transform circuit 404 may transform each ToF measurement 402 into a lower dimensional space. In general, transform circuit 404 may transform each ToF measurement 402 into any lower dimensional space, such as a space that approximates the ToF measurement. Some illustrative transforms that may be applied to ToF measurements 402 are shown in FIGS. 5A-5D.

As shown in FIG. 5A, each ToF measurement 402 may be transformed using transform 500. Transform 500 may be a CORDIC (coordinate rotation digital computer) algorithm. In other words, each ToF measurement 402 may be transformed onto the circumference of a circle in the complex plane that includes real and imaginary parts. Each ToF measurement 402 may be transformed into a vector, such as vector 501. Vector 501 may have angle measured anticlockwise from to the real axis, hereafter referred to as the argument Θ 505 Argument 505 may reflect the ToF measurement 402 (e.g., the ToF of the light received by the respective SPAD pixel 202). Vector 501 may be a unit vector, such as a Euclidean unit vector (where the vector x+iy satisfies \sqrt{x²+y²}=1). Alternatively, vector 501 may be a vector of any suitable known length.

Transform 500 may be a CORDIC algorithm and implemented using Equation 1,

$$x + iy = {e}^{\frac{j 2 π r}{R}} \qquad ( 1 )$$

where x+iy is the vector produced by transform 500, with real part x and imaginary part y, r is the time stamp received by a given SPAD pixel, and R is a maximum range, such as a power of 2 or other suitable maximum range (e.g., 32 in FIG. 5A). In this way, each ToF measurement 402 may be transformed into a unit vector, x+iy, with an argument that corresponds to the ToF.

Instead of transform circuitry 404 using CORDIC transform 500, square transform 502 may be used, as shown in FIG. 5B. In other words, each TOF measurement 402 may be transformed onto a point on the perimeter of a square on the complex plane. In particular, square transform 502 may include real and imaginary parts. Each ToF measurement 402 may be transformed into a vector with constant Chebyshev distance (or other known length), such as vector 511. Vector 511 may have argument Q 509 with respect to the real axis. Argument 509 may reflect the ToF measurement 402 (e.g., the ToF of the light received by the respective SPAD pixel 202).

Square transform 502 may be a conditional add/subtract algorithm that is an approximation of CORDIC transform 500. Square transform 502 may be implemented using Equation 2,

$$x + iy = \{ \begin{matrix}\frac{R}{8} + i ( ( ( r + \frac{R}{4} ) mod R ) - \frac{R}{4} ) & : & r < \frac{R}{8} \vert r \geq \frac{7 R}{8} \\ \frac{R}{4} - r + i ( \frac{R}{8} ) & : & r \geq \frac{R}{8} \& r < \frac{3 R}{8} \\ - \frac{R}{8} + i ( \frac{R}{2} - r ) & : & r \geq \frac{3 R}{8} \& r < \frac{5 R}{8} \\ r - \frac{3 R}{4} - i ( \frac{R}{8} ) & : & r \geq \frac{5 R}{8} \& r < \frac{7 R}{8}\end{matrix} \} \qquad ( 2 )$$

where x+iy is the vector produced by square transform 502, with real part x and imaginary part y, r is the time stamp received by a given SPAD pixel, and R is a maximum range, such as a power of 2 or other suitable maximum range (e.g., 32 in FIG. 5B). As shown in Equation 2, square transform 502 may be implemented as a conditional add/subtract based on the relative values of r and R.

Instead of transform circuitry 404 using CORDIC transform 500 or square transform 502, diagonal transform 503 may be used, as shown in FIG. 5C. In other words, each ToF measurement 402 may be transformed onto a point on the perimeter of a diagonal square. The diagonal square may lie on the complex plane and be aligned so that its edges are at 45° to the real and imaginary axes. Diagonal transform 503 may be a conditional add/subtract algorithm that is an approximation of CORDIC transform 500 and may be implemented using Equation 3,

$$x + iy = \{ \begin{matrix}\frac{R}{4} - r + ir & : & r < \frac{R}{4} \\ \frac{R}{4} - r + i ( \frac{R}{2} - r ) & : & r \geq \frac{R}{4} \& r < \frac{R}{2} \\ r - \frac{3 R}{4} + i ( \frac{R}{2} - r ) & : & r \geq \frac{R}{2} \& r < \frac{3 R}{4} \\ r - \frac{3 R}{4} + i ( r - R ) & : & r \geq \frac{3 R}{4} \& r < R\end{matrix} \} \qquad ( 3 )$$

where x+iy is the vector produced by diagonal transform 503, with real part x and imaginary part y, r is the time stamp received by a given SPAD pixel, and R is a maximum range, such as a power of 2, or other suitable maximum range (e.g., 32 in FIG. 5C). As shown in Equation 3, diagonal transform 503 may be implemented as a conditional add/subtract based on the relative values of r and R.

Instead of transform circuitry 404 using CORDIC transform 500, square transform 502, or diagonal transform 503, octagonal transform 504 may be used, as shown in FIG. 5C. In other words, each TOF measurement 402 may be transformed onto a point on the perimeter of an octagon. Octagonal transform 504 may be a conditional add/subtract algorithm that is an approximation of CORDIC transform 500 and may be implemented using Equation 4,

$$I = \{ \begin{matrix}\frac{N}{4} & \vert & 0 \leq n < \frac{N}{16} \\ \frac{5 N}{16} - n & \vert & \frac{N}{16} \leq n < \frac{3 N}{16} \\ \frac{N}{2} - 2 n & \vert & \frac{3 N}{16} \leq n < \frac{5 N}{16} \\ \frac{3 N}{16} - n & \vert & \frac{5 N}{16} \leq n < \frac{7 N}{16} \\ - \frac{N}{4} & \vert & \frac{7 N}{16} \leq n < \frac{9 N}{16} \\ n - \frac{13 N}{16} & \vert & \frac{9 N}{16} \leq n < \frac{11 N}{16} \\ 2 n - \frac{3 N}{2} & \vert & \frac{11 N}{16} \leq n < \frac{13 N}{16} \\ n - \frac{11 N}{16} & \vert & \frac{13 N}{16} \leq n < \frac{15 N}{16} \\ \frac{N}{4} & \vert & \frac{15 N}{16} \leq n < N\end{matrix} \} , \\ Q = \{ \begin{matrix}2 n & \vert & 0 \leq n < \frac{N}{16} \\ n + \frac{N}{16} & \vert & \frac{N}{16} \leq n < \frac{3 N}{16} \\ \frac{N}{4} & \vert & \frac{3 N}{16} \leq n < \frac{5 N}{16} \\ \frac{9 N}{16} - 4 & \vert & \frac{5 N}{16} \leq n < \frac{7 N}{16} \\ N - 2 n & \vert & \frac{7 N}{16} \leq n < \frac{9 N}{16} \\ \frac{7 N}{16} - n & \vert & \frac{9 N}{16} \leq n < \frac{11 N}{16} \\ - N / 4 & \vert & \frac{13 N}{16} \leq n < \frac{13 N}{16} \\ n - \frac{17 N}{16} & \vert & \frac{13 N}{16} \leq n < \frac{15 N}{16} \\ 2 n - N & \vert & \frac{15 N}{16} \leq n < N\end{matrix} \} \qquad ( 4 )$$

where I and Q are the real and imaginary parts, respectively, of a vector I+Qi (also referred to as x+iy) produced by octagonal transform 504, n is the time stamp received by a given SPAD pixel, and N is a maximum range, such as a power of 2 or other suitable maximum range (e.g., 32 in the example of FIG. 5D). As shown in Equation 4, octagonal transform 504 may be implemented as a conditional add/subtract based on the relative values of n and N.

In general, however, any suitable transform may be used by transform circuit 404 to transform ToF measurements 402 into a lower dimensional space, such as into vectors x+iy (or I+Qi of octagonal transform 504). As discussed, ToF measurements 402 may be transformed into vectors on a two-dimensional complex plane. Alternatively, ToF measurements 402 may be transformed into gray coded values or may be transformed into gray coded values after error correction operations, as examples.

Regardless of the transform used by transform circuit 404 to transform ToF measurements 402 into a lower dimensional space, the transformed values, such as vectors x+iy, may be passed from transform circuit 404 to integration circuit 406, as shown in FIG. 4.

Integration circuit 406 may add or otherwise combine each of the transformed values, such as vectors x+iy, as they are produced by transform circuit 404. For example, if vectors x+iy are produced for each ToF measurement using one of the transforms in FIGS. 5A-5D, integration circuit 406 may add these vectors.

Because each complex vector has an argument corresponding to the ToF measured by one of the SPADs, adding or otherwise combining the complex vectors produced for each SPAD pixel will result in a large vector, the argument of which will approximate the ToF to the external object. In particular, there may be many vectors that correspond to a SPAD pixel measurement of light that has reflected from the external object. In other words, the vectors may have arguments that correspond to the correct ToF associated with the external object. In contrast, vectors that correspond to noise, such as ambient light, may have random arguments (e.g., random ToFs) in the transformed space. When these vectors are added together, the vectors corresponding to noise will mostly or entirely cancel out, such as by summing to zero, while the vectors corresponding to the external object will predominate and provide an estimation of the ToF associated with the external object. An illustrative example of combining the transform vectors is shown in FIG. 6.

As shown in FIG. 6, vector integration 600 may include individual vectors 602A and 602B. Vectors 602A and 602B may each have argument Q 604 from axis 608 (e.g., a real axis in a transformed space, as shown in FIGS. 5A and 5B). Vectors 602A may be transformed values of ToF measurements 402 that correspond to light that has reflected from the external target, while vectors 602B may be attributable to noise. By adding vectors 602A and 602B, vectors 602B will approximately cancel out (e.g., sum to zero or approximate zero), while vectors 602A may add to a vector of a high magnitude at the same argument (e.g., the argument that corresponds to the ToF associated with the external object).

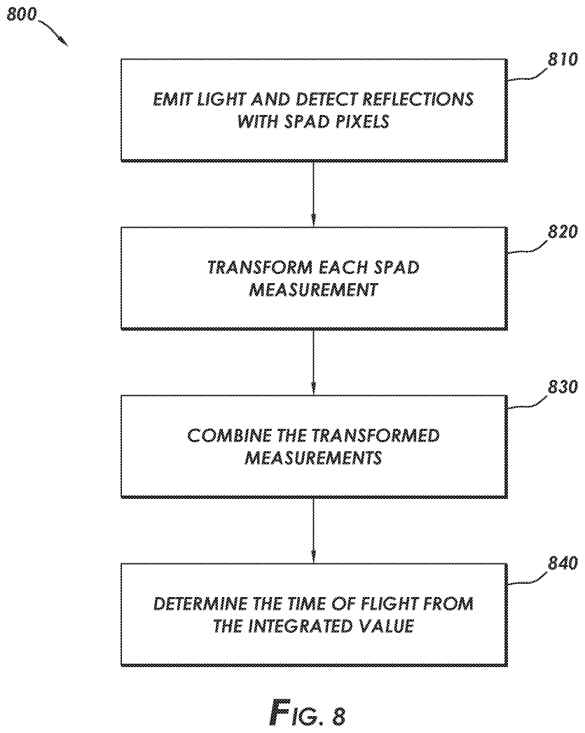

As shown in FIG. 4, after all of the vectors have been integrated by integration circuit 406, decoding circuit 408 may convert the integrated value into filtered ToF value 410. For example, decoding circuit 408 may transform the integrated value into filter ToF value 410. In particular, decoding circuit 408 may convert the final x+iy vector back into a ToF by calculating a ToF value, or a range of ToF values, based on the argument of the integrated vector. In this way, the ToF associated with the external object may be determined. An illustrative example of determining a filtered ToF value is shown in FIG. 7.

As shown in FIG. 7, integrated vector 702 may be received by decoding circuit 408. In other words, integrated vector 702 may be the resulting vector from adding or otherwise combining all of the transformed vectors produced by transform circuit 404. Integrated vector 702 may have argument Q 704 with respect to axis 708. Axis 708 may correspond to the real axis in the transformed space, as shown in FIGS. 5A-5D.

Decoding circuit 408 may determine argument 704 of integrated vector 702. Based on argument 704, decoding circuit 408 may determine a ToF, or range of ToFs that match argument 704 (e.g., by using the original transform that was used by transform circuit 404). In this way, decoding circuit 408 may determine a ToF from the integrated vector.

Decoding circuit 408 may determine argument 704 by using a reverse mapping (e.g., based on the transform used by integration circuit 406). For example, if diagonal transform 503 of FIG. 5C is used, then the resulting integrated vector may be decoded by decoding circuit using Equation 5,

$${n}_{s} = \{ \begin{matrix}\frac{N}{4} - \frac{IN}{4 ( I + Q )} & \vert & I > 0 , Q \geq 0 \\ \frac{N}{4} - \frac{IN}{4 ( Q - I )} & \vert & I \leq 0 , Q > 0 \\ \frac{3 N}{4} - \frac{IN}{4 ( I + Q )} & \vert & I < 0 , Q \leq 0 \\ \frac{3 N}{4} + \frac{IN}{4 ( I - Q )} & \vert & I \geq 0 , Q < 0\end{matrix} \} = \{ \begin{matrix}\frac{QN}{4 ( I + Q )} & \vert & I > 0 , Q \geq 0 \\ \frac{N}{2} - \frac{QN}{4 ( Q - I )} & \vert & I \leq 0 , Q > 0 \\ \frac{N}{2} + \frac{QN}{4 ( I + Q )} & \vert & I < 0 , Q \leq 0 \\ N + \frac{QN}{4 ( I - Q )} & \vert & I \geq 0 , Q < 0\end{matrix} \} \qquad ( 5 )$$

where nₛ is the argument; N is a maximum range (corresponding to R of Equation 3), such as a power of 2, or other suitable maximum range (e.g., 32 in FIG. 5C); and I and Q are the real and imaginary parts of integrated vector x+iy (e.g, I+Qi), respectively.

As another example, if octagonal transform 504 of FIG. 5D is used, then the resulting integrated vector may be decoded by decoding circuit using Equation 6,

$${n}_{s} = ( \begin{matrix}\frac{QN}{8 I} & \vert & 0 < I \& 0 \leq Q \& Q < \frac{I}{2} \\ \frac{3 QN}{8 ( Q + I )} - \frac{N}{16} & \vert & 0 < I \& 0 < Q \& I > \frac{Q}{2} \& Q \geq \frac{I}{2} \\ \frac{N}{4} - \frac{IN}{8 Q} & \vert & I < 0 \& Q > 0 \& I \leq \frac{Q}{2} \& I > - \frac{Q}{2} \\ \frac{3 N}{16} - \frac{3 NI}{8 ( Q - I )} & \vert & Q > 0 \& I < 0 \& I \leq \frac{Q}{2} \& Q > - \frac{I}{2} \\ \frac{N}{2} + \frac{NQ}{8 I} & \vert & I < 0 \& Q \leq - \frac{I}{2} \& Q > - \frac{I}{2} \\ \frac{7 N}{16} + \frac{3 NQ}{8 ( I + Q )} & \vert & I < 0 \& Q < 0 \& I < \frac{Q}{2} \& Q \leq \frac{I}{2} \\ \frac{3 N}{4} - \frac{NI}{8 Q} & \vert & Q < 0 \& I \geq \frac{Q}{2} \& I < - \frac{Q}{2} \\ \frac{17 N}{16} - \frac{3 NQ}{8 ( Q - I )} & \vert & I > 0 \& Q < 0 \& I \geq - \frac{Q}{2} \& Q < - \frac{I}{2} \\ N + \frac{NQ}{8 I} & \vert & I > 0 \& Q < 0 \& Q \geq - \frac{I}{2}\end{matrix} ) \qquad ( 6 )$$

where nₛ is the argument; N is a maximum range (corresponding to R of Equation 3), such as a power of 2, or other suitable maximum range (e.g., 32 in FIG. 5C); and I and Q are the real and imaginary parts of integrated vector x+iy (e.g, I+Qi), respectively.

However, Equations 5 and 6 are merely illustrative examples of decoding equations that may be used to determine the argument of the integrated vector. In general, any suitable decoding equation may be used to determine the argument of the integrated vector based on the transform used by transform circuit 404. In this way, decoding circuit 408 may determine the argument of the integrated circuit and determine the ToF.

In addition to determining the ToF from argument 704 of integrated vector 702, the length of vector 702 may provide an indication of a reliable result. For example, if vector 702 has a large magnitude, then a large number of the individual transformed vectors that were integrated to form vector 702 had similar arguments and therefore a similar ToF to vector 702. In this way, the magnitude of vector 702 may be an indication of reliability. In some embodiments, processing circuitry, such as LIDAR processing circuitry 120 (FIG. 1), may discard measurements in which the final integrated vector is below a threshold, such as below 5, 10, or 15 in magnitude, as examples. However, this is merely illustrative. Processing circuitry, such as LIDAR processing circuitry 120 may keep or discard any desired measurements.

Integrated vector 702 may fall within a range of uncertainty, illustratively shown by circle 706. In particular, by combining transformed vectors to form integrated vector 702, the resulting ToF measurement is an approximation of the actual ToF. However, this process will always return a value (e.g., the integrated vector), which may be used to approximate the ToF using the argument of the integrated vector.

Based on filtered ToF 410, LIDAR processing circuitry 120 or other circuitry may determine the distance to the external object. By transforming each SPAD measurement, a direct ToF LIDAR module may determine the ToF to an external object using less memory. Flowchart 800 of illustrative steps that may be used to make this determination using a direct ToF system is shown in FIG. 8.

As shown in FIG. 8, at step 810, a LIDAR system, such as LIDAR module 102 of FIG. 1, may emit light and detect reflections of the emitted light with SPAD pixels. In some embodiments, the LIDAR system may emit light toward an external object, such as by using beam steering or otherwise modifying the emitted light to be directed toward the external object, or may otherwise illuminate a scene that includes an object of interest. The SPAD pixels may produce measurements in response to light that has reflected off of the external object, and these measurements may be used to calculate the ToF required for the emitted light to return to the LIDAR system.

At step 820, each of the SPAD measurements may be transformed into a lower dimensional space. In particular, the SPAD measurements may include information regarding the ToF associated with the external object. The SPAD measurements may be transformed into unit vectors on a two-dimensional complex plane with arguments that represent the SPAD measurements. As examples, one of the transforms in FIGS. 5A-5D and Equations 1-4 may be used to transform the SPAD measurements onto a two-dimensional complex plane, or the SPAD measurements may be transformed into gray coded values. In general, however, any suitable transform may be sued to transform the SPAD measurements into a lower dimension.

At step 830, the transformed SPAD measurements may be combined (e.g., integrated). In particular, the SPAD measurements may be added or otherwise combined. For example, if the SPAD measurements are converted to vectors on a two-dimensional complex plane, each of the transformed x+yi vectors may be summed. The integration may occur immediately after each of the transformed SPAD measurements is produced. In other words, each transformed SPAD measurement may be added to the previous integrated value. Alternatively, integration may occur after a desired number of transformed SPAD measurements have been produced, such as after every two, three, five, or other suitable number of SPAD measurements, or the transformed SPAD measurements may be summed after all of the SPAD measurements have been transformed. In this way, an integrated transformed SPAD measurement may be produced.

At step 840, the ToF may be determined from the integrated transformed SPAD measurement. In particular, the final integrated measurement may be converted (e.g., transformed) into a ToF value or range of values. For example, if the original SPAD measurements were transformed into vectors, each vector may be a unit vector having an argument that corresponds to the SPAD measurement. Adding or otherwise combining the vectors produced for each SPAD pixel will provide an approximation of the ToF.

For example, there may be many transformed vectors having the same (or similar) argument that correspond to a SPAD pixel measurement of light that has reflected from the external object. In contrast, vectors that correspond to noise, such as ambient light, may have varying (e.g., random) directions (ToFs). When these vectors are added together, the vectors corresponding to noise will mostly cancel out, such as summing to zero, while the vectors corresponding to the external object will predominate and provide an estimation of the ToF associated with the external object. By transforming each SPAD measurement, a direct ToF LIDAR module may determine the ToF to an external object using less memory.

It will be recognized by one skilled in the art that the present exemplary embodiments may be practiced without some or all of these specific details. In other instances, well-known operations have not been described in detail in order not to unnecessarily obscure the present embodiments.

The foregoing is merely illustrative and various modifications can be made to the described embodiments. The foregoing embodiments may be implemented individually or in any combination.

What is claimed is:

1. A light detection and ranging device, comprising:
a plurality of single photon avalanche diodes configured to produce measurements in response to light;
a transform circuit coupled to the single photon avalanche diodes and configured to transform the measurements from a first dimensional space to a second dimensional space that is lower than the first dimensional space;
an integration circuit configured to combine the transformed measurements; and
a decoding circuit configured to determine a time-of-flight based on the integrated transformed measurements.

2. The light detection and ranging device of claim 1, wherein the second dimensional space comprises a two-dimensional complex plane, and wherein each of the transformed measurements comprise vectors on the two-dimensional complex plane.

3. The light detection and ranging device of claim 2, wherein the transform circuit is configured to transform the measurements onto a perimeter of a square on the two-dimensional complex plane.

4. The light detection and ranging device of claim 3, wherein the square is a diagonal square with edges that are at 45° to real and imaginary axes of the two-dimensional complex plane.

5. The light detection and ranging device of claim 2, wherein the transform circuit is configured to transform the measurements onto a perimeter of an octagon on the two-dimensional complex plane.

6. The light detection and ranging device of claim 2, wherein the transform circuit is configured to transform the measurements onto a circumference of a circle on the two-dimensional complex plane.

7. The light detection and ranging device of claim 2, wherein the transform circuit is configured to transform the measurements from the first dimensional space to the second dimensional space using a coordinate rotation digital computer (CORDIC) transform.

8. The light detection and ranging device of claim 2, wherein the integration circuit is configured to combine the transformed measurements by summing the vectors as they are produced by the transform circuit to produce a summed vector.

9. The light detection and ranging device of claim 8, wherein the decoding circuit is configured to determine the time-of-flight based on an argument of the summed vector.

10. A method of operating a light detection and ranging device, the method comprising:
emitting laser light and detecting reflections of the laser light using single photon avalanche diode pixels to produce measurements;
transforming each of the measurements from a first dimensional space to a second dimensional space that is lower than the first dimensional space to produce transformed measurements; and
combining the transformed measurements.

11. The method of claim 10, wherein transforming each of the measurements comprises transforming each of the measurements into a vector in a two-dimensional complex plane to produce the transformed measurements.

12. The method of claim 11, wherein integrating the transformed measurements comprises adding the vectors to form an integrated vector.

13. The method of claim 12, further comprising:
after adding the vectors, determining a time-of-flight based on the integrated vector.

14. The method of claim 13, wherein determining the time-of-flight comprises determining a distance to an external object.

15. The method of claim 11, wherein the transforming each of the measurements into a vector in a two-dimensional complex plane comprises transforming each of the measurements onto a perimeter of a square on the two-dimensional complex plane.

16. The method of claim 11, wherein the transforming each of the measurements into a vector in a two-dimensional complex plane comprises transforming each of the measurements onto the perimeter of the square with edges that are at 45° to axes of the two-dimensional complex plane.

17. The method of claim 11, wherein the transforming each of the measurements into a vector in a two-dimensional complex plane comprises transforming each of the measurements onto a perimeter of an octagon on the two-dimensional complex plane.

18. A light detection and ranging device configured to produce a direct time-of-flight measurement in response to an external object, the light detection and ranging device comprising:
a laser configured to emit light toward the external object;
a plurality of single photon avalanche diodes configured to generate signals in response to reflected light from the external object;
a transform circuit configured to transform the generated signals to produce transformed signals;
an integration circuit configured to combine the transformed signals to produce an integrated signal; and
a decoding circuit configured to produce the direct time-of-flight measurement based on the integrated signal.

19. The light detection and ranging device of claim 18, wherein the transform circuit is configured to transform the generated signals from a first dimensional space to a second dimensional space that is lower than the first dimensional space.

20. The light detection and ranging device of claim 19, wherein the second dimensional space comprises a two-dimensional complex plane, wherein each of the transformed signals comprises vectors on the two-dimensional complex plane, and wherein the integration circuit is configured to produce the integrated signal by adding the vectors.
